(19) United States
(12) Patent Application Publication
(10) Pub. No.: US 2011/0006590 A1
(43) Pub. Date: Jan. 13, 2011

(54) Bicycle rim

(76) Inventor: Chun Hsun Lo, Changhua Hsien (TW)

Correspondence Address: CHARLES E. BAXLEY, ESQUIRE, 90 JOHN STREET, SUITE 403, NEW YORK, NY, 10038, US

(21) Appl. No.: 12/657,058

(22) Filed: Jan. 13, 2010

(30) Foreign Application Priority Data
Jul. 8, 2009 (TW) 098212377

(51) Int. Cl. B60B 21/04

(52) U.S. Cl. 301/95.11

(57) ABSTRACT

A rim includes an external ring and an internal ring. The external ring includes two walls each including a brake-contacting face, a middle portion interconnecting the walls, a bead-receiving groove defined by the walls and the intermediate portion, two external flanges extending from the middle portion opposite to the walls, two internal flanges extending from the middle portion opposite to the walls. An edge-receiving groove is defined between each of the external flanges and a related one of the internal flanges. The internal ring includes two walls and an intermediate portion interconnecting the walls. Each of the walls of the internal ring includes an edge inserted in a related one of the edge-receiving grooves, a shoulder abutted against. a related one of the external flanges, and an external side in flush with the brake-contacting face of a related one of the walls of the external ring.

### BACKGROUND OF INVENTION

1. Field of Invention

The present invention relates to a bicycle and, more particularly, to a rim for use in a bicycle.

2. Related Prior Art

For the sake of environment protection and sport, bicycles have become popular vehicles particularly for short-distance travelers in urban areas. Functionality and styling are important factors taken into consideration by riders looking for bicycles. Collapsible bicycles are examples of such consideration. In addition to functionality and styling, strength and safety are also important factors taken into consideration by riders. This is the primary incentive for using aluminum alloy and carbon fiber rims in bicycles.

A method for making a carbon rim includes the steps of forming an inflated semi-product in a mold, inserting an air bag in the semi-product, inflating the air bag, heating the mold, taking the semi-product and the air bag from the mold, baking, and grinding. A carbon rim is of course light in weight; however, it is difficult to control the air pressure in the air bag and the heating of the mold. Hence, it takes about 90 minutes to finish a carbon rim, and the cost of a carbon rim is high.

Referring to FIGS. 10 and 11, there is shown a conventional rim made of aluminum alloy. A method for making such a conventional aluminum alloy rim includes the steps of extrusion, rolling, cutting, trimming, welding, and grinding in sequence. The conventional aluminum alloy rim includes two walls 51 and 52 interconnected by an intermediate portion 53. A bead-receiving groove 54 is defined by the walls 51 and 52 and the intermediate portion 53. It is desired to make the rim with large depth in a radial direction; however, such an attempt entails risks of making wrinkles 55 on the walls 51 and 52 since they cannot be supported from the inside to keep them flat during the rolling. Therefore, the depth of a conventional aluminum alloy rim cannot exceed 32 mm.

The present invention is therefore intended to obviate or at least alleviate the problems encountered in prior art.

### SUMMARY OF INVENTION

It is the primary objective of the present invention to provide a bicycle with a light and robust rim.

To achieve the foregoing objective of the present invention, the rim includes an external ring and an internal ring. The external ring includes two walls each including a brake-contacting face, a middle portion interconnecting the walls, a bead-receiving groove defined by the walls and the intermediate portion, two external flanges extending from the middle portion opposite to the walls, and two internal flanges extending from the middle portion opposite to the walls. The internal flanges are located between the external flanges in an axial direction of the rim. An edge-receiving groove is defined between each of the external flanges and a related one of the internal flanges. The internal ring includes two walls and an intermediate portion interconnecting the walls. Each of the walls of the internal ring includes an adequate dimension in the radial direction of the rim. Each of the walls of the internal ring includes an edge inserted in a related one of the edge-receiving grooves, a shoulder abutted against. a related one of the external flanges, and an external side in flush with the brake-contacting face of a related one of the walls of the external ring.

Other objectives, advantages and features of the present invention will become apparent from the following description referring to the attached drawings.

### BRIEF DESCRIPTION OF DRAWINGS

The present invention will be described via detailed illustration of three embodiments versus prior art referring to the drawings, where:

FIG. 1 is a flow chart of a method for making a rim according to the first embodiment of the present invention;

FIG. 2 is a cross-sectional view of a rim according to the first embodiment of the present invention;

FIG. 3 is an exploded view of the rim shown in FIG. 2;

FIG. 4 is a cross-sectional view of the rim shown in FIG. 2, but in another position;

FIG. 5 is a perspective view of the rim shown in FIG. 4;

FIG. 6 is a cross-sectional view of the rim shown in FIG. 4, but in another position;

FIG. 7 is a perspective view of the rim shown in FIG. 6;

FIG. 8 is a flow chart of another method for making the rim according to the first embodiment of the present invention;

FIG. 9 is a cross-sectional view of a rim according to the second embodiment of the present invention;

FIG. 10 is a cross-sectional view of a rim according to the third embodiment of the present invention;

FIG. 11 is a cross-sectional view of a conventional rim; and

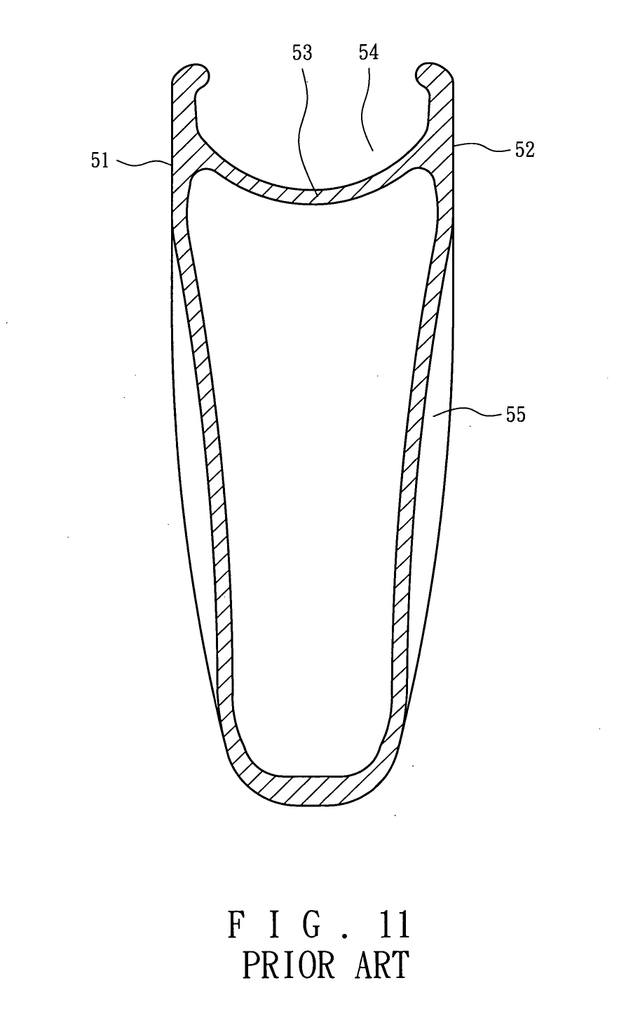

FIG. 12 is a partial perspective view of the rim shown in FIG. 10.

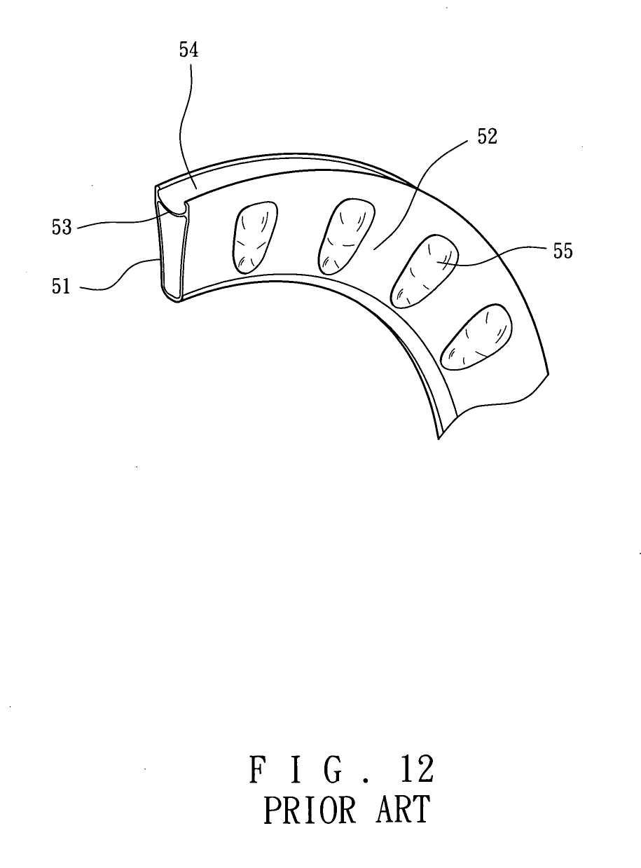

### DETAILED DESCRIPTION OF EMBODIMENTS

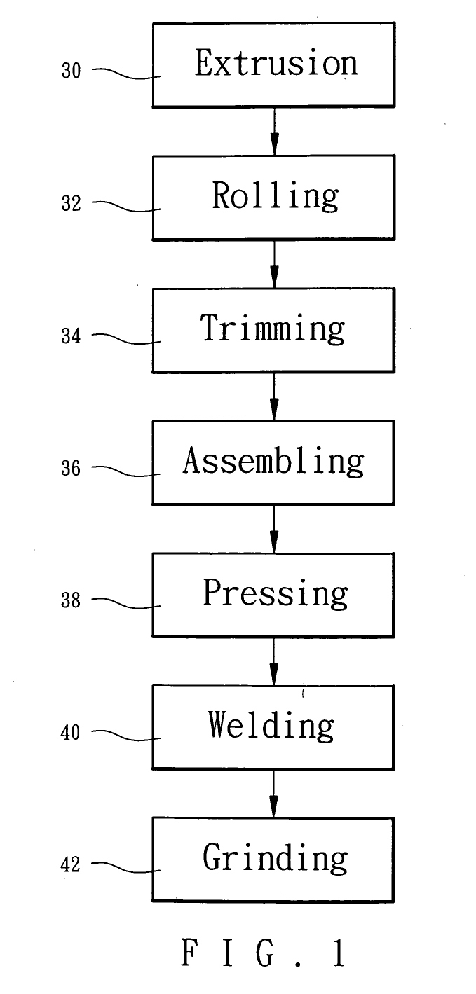

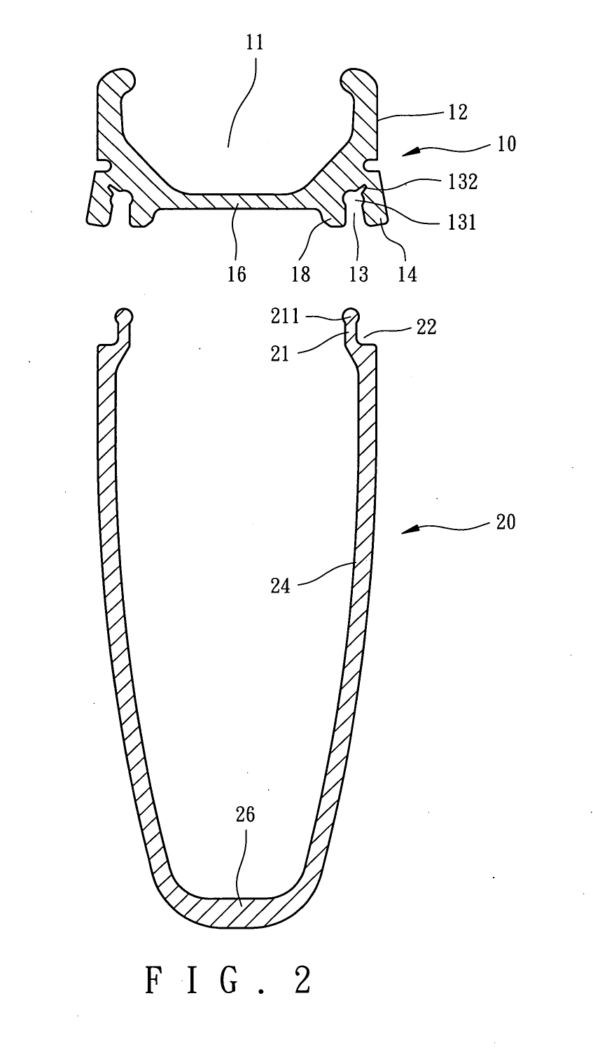

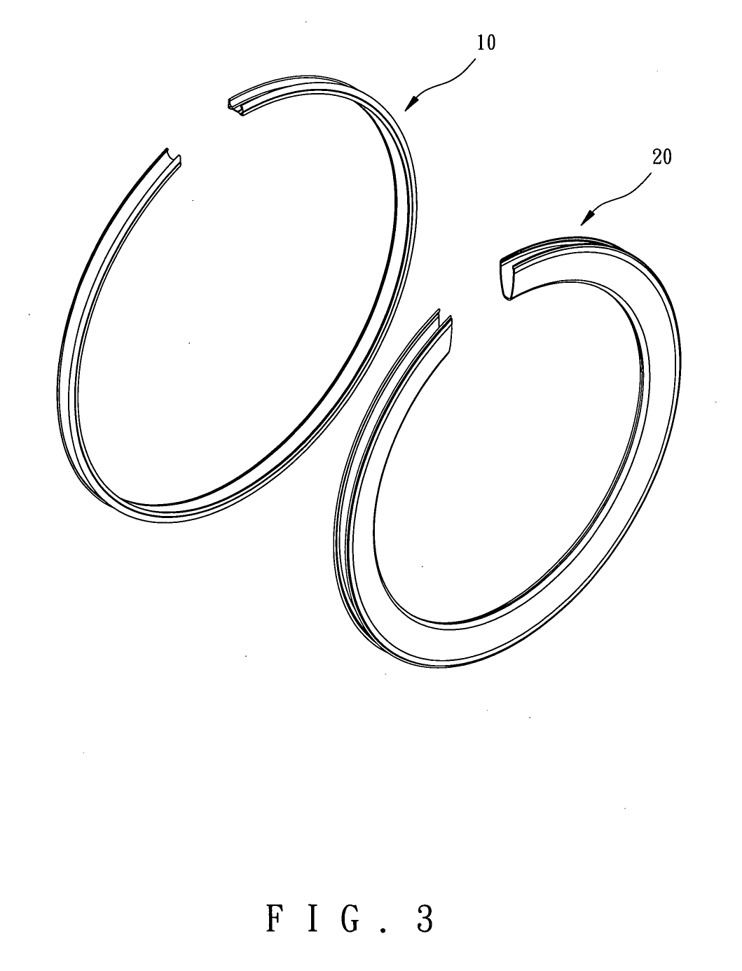

Referring to FIG. 1, there is shown a method for making a rim (FIGS. 2 and 3) according to a first embodiment of the present invention as shown. The rim includes an internal ring 10 and an external ring 20 that are made separately and later assembled. At 30, by extrusion of stainless, magnesium or aluminum alloy, a first bar of material is made, and so is a second bar of material.

At 32, by rolling and cutting, a section of the first bar of material is made into an arched section of material (“unfinished external ring”) and cut from the first bar of material. Similarly, a section of the second bar of material is made into an arched section of material (“unfinished internal ring”) and cut from the first bar of material. Both of the unfinished external and internal rings look like a “C” along an axis about which the external ring 10 and the internal ring 20 are supposed to spin.

The lengths of the unfinished external and internal rings are larger than desired perimeters of the external ring 10 and the internal ring 20 because the cohesion of the molecules of the material and stress exerted on the material tend to make the material shrink after the rolling and cutting. At 34, by trimming, excessive portions are cut from the unfinished external and internal rings. Therefore, the lengths of the unfinished external and internal rings are made equal to the desired perimeters of the external ring 10 and the internal ring 20. Moreover, the ends of the unfinished external and internal rings are made neat.

The external ring 10 includes two walls 12 and a middle portion 16 that interconnects the walls 12. The walls 12 extend from a first, external side of the middle portion 16. Each of the walls 12 includes an external, brake-contacting face. The brake-contacting face is generally in a plane in perpendicular to the axis. A bead-receiving groove 11 is defined by the walls 12 and the intermediate portion 16.

Two external flanges 14 extend from a second, internal side of the middle portion 16. Spacing of the internal side of the middle portion 16 from the axis is smaller than spacing of the external side of the middle portion 16. Spacing between the external flanges 14 increases as the external flanges 14 extend from the internal side of the middle portion 16.

Two internal flanges 18 also extend from the internal side of the middle portion 16. The internal flanges 18 are located between the external flanges 14 in an axial direction of the rim.

An edge-receiving groove 13 is defined between each of the external flanges 14 and a related one of the internal flanges 18. Hence, there are two edge-receiving grooves 13 each including an open end and a closed. Because of the opening external flanges 14, a width of the edge-receiving grooves 13 increases from the closed end to the open end. Each of the edge-receiving grooves 13 includes an enlarged portion 131. The width of the edge-receiving grooves 13 decreases from the open end to the closed end except within the enlarged portions 131.

A slit 132 is defined in the closed end of each of the edge-receiving grooves 13. Each of the slits 132 extends toward the brake-contacting face of the related wall 12 of the external ring 10 from the closed end of the related edge-receiving groove 13.

The internal ring 20 includes two walls 24 and an intermediate portion 26 that interconnects the walls 24. The walls 24 are made with an adequate dimension in the radial direction of the rim for the purposes of strength and security. Each of the walls 24 includes an edge 21 and a shoulder 22. Spacing between the edges 21 is smaller than spacing between major portions of the walls 24 so that the shoulders 22 are formed between the edges 21 and the major portions of the walls 24. Each of the edges 21 includes an enlarged portion 211. The enlarged portion 211 looks like a ball as shown in FIG. 2.

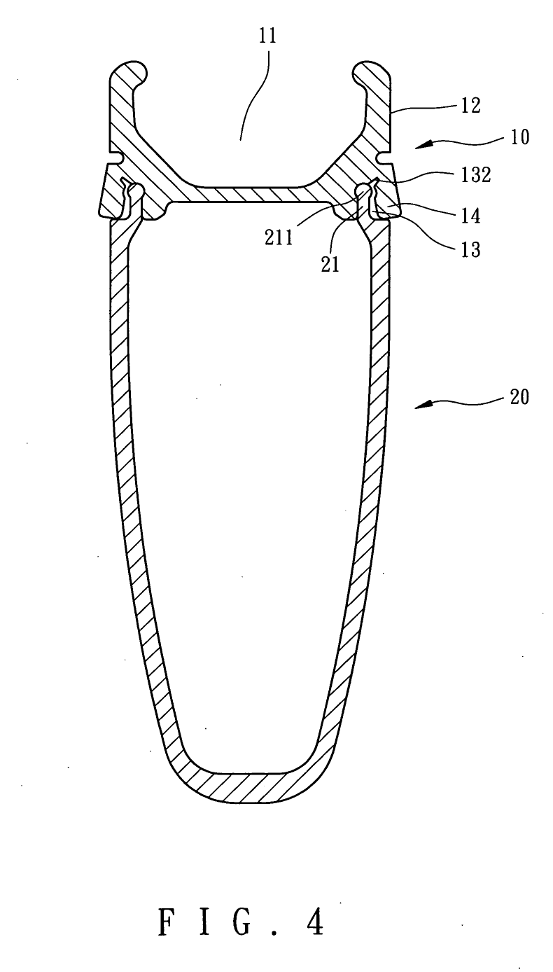

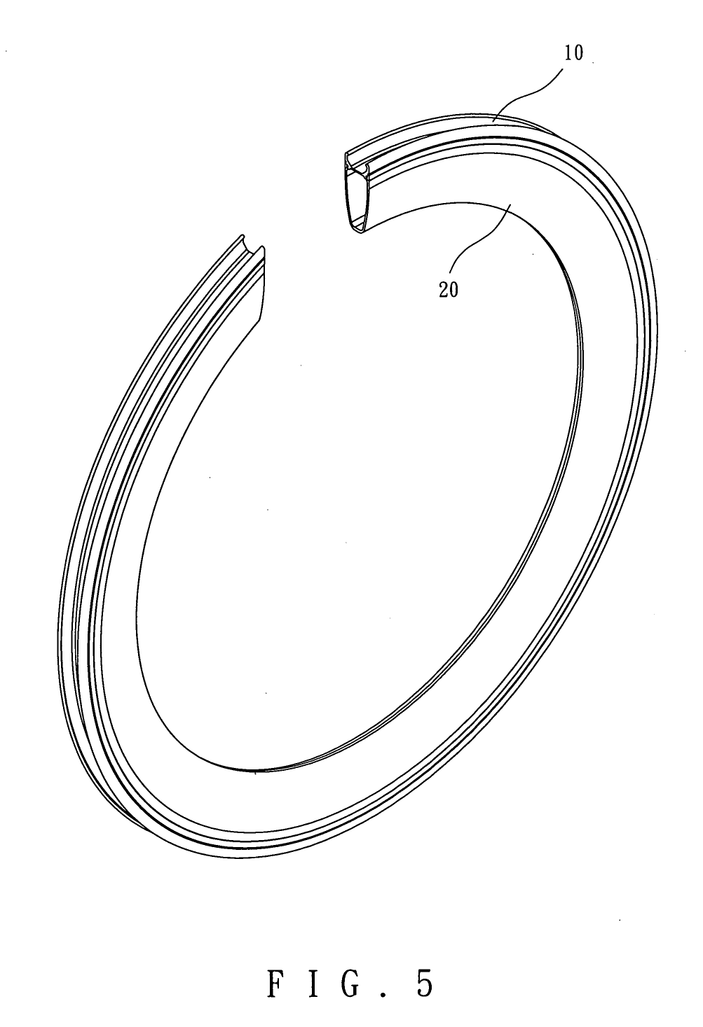

At 36, the unfinished external and internal rings are assembled as shown in FIGS. 4 and 5. In detail, the edges 21 are inserted in the edge-receiving grooves 13, thus interconnecting the unfinished internal and external rings. The enlarged portions 211 of the edges 21 are fit in the enlarged portions 131 of the edge-receiving grooves 13, thus enhancing the interconnection of the unfinished internal and external rings. The increasing width of the edge-receiving grooves 13 facilitates the insertion of the enlarged portions 211 of the edges 21 into the edge-receiving grooves 13. The shoulders 22 abut the external flanges 14 to enhance the strength of the rim in the radial direction.

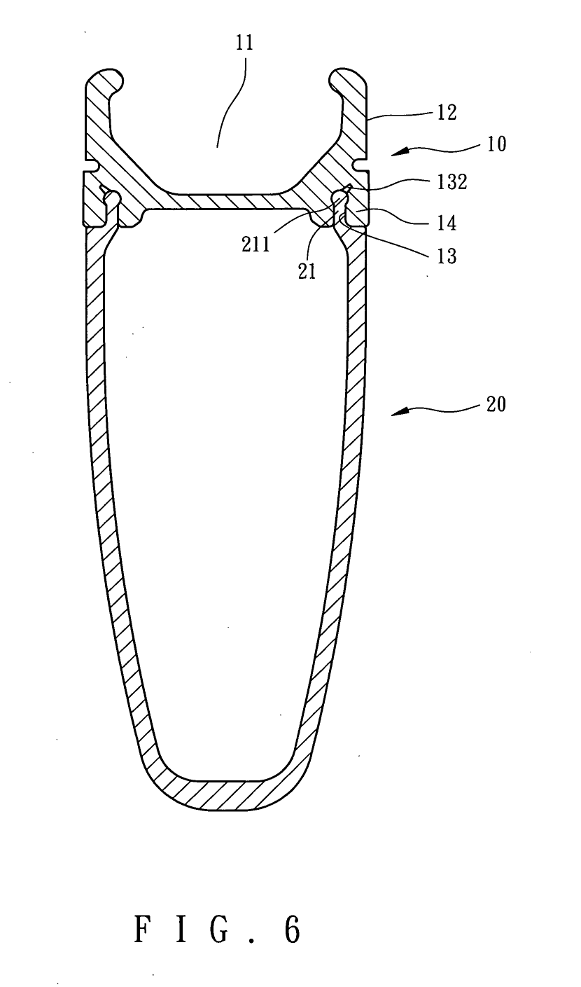

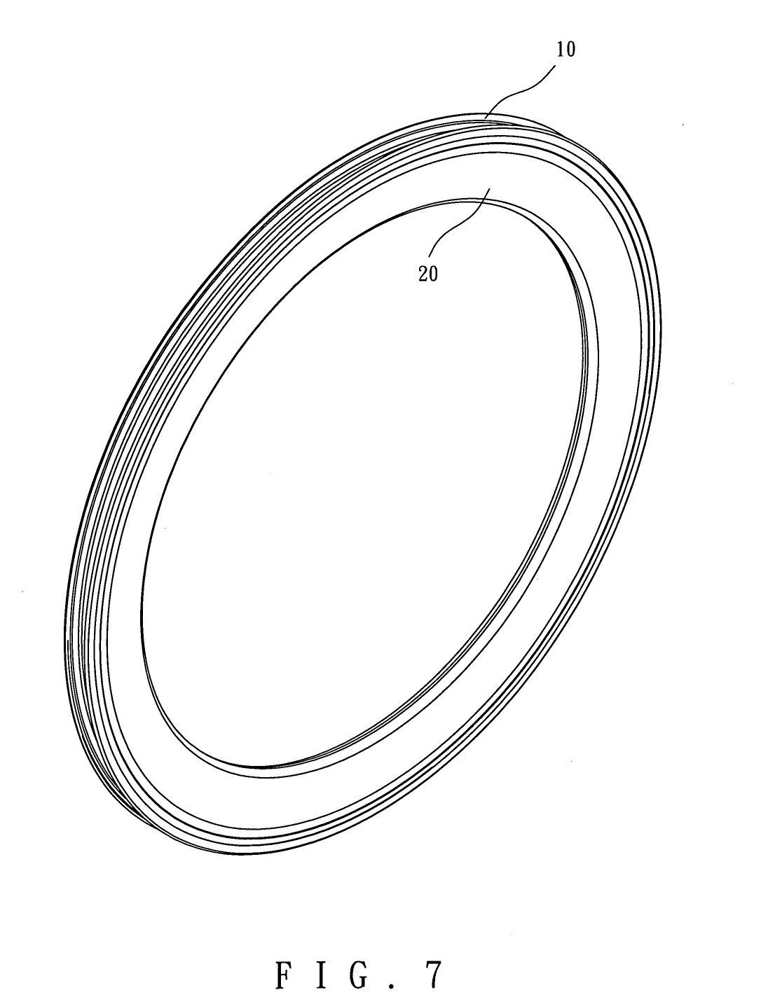

At 38, by pressing, the external flanges 14 are closed as shown in FIGS. 6 and 7. Thus, each of the edges 21 is firmly sandwiched between a related one of the external flanges 14 and a related one of the internal flanges 18. Moreover, the enlarged portions 211 of the edges 21 are retained in the enlarged portions 131 of the edge-receiving grooves 13. The slits 132 reduce stress within the external flanges 14 of the external ring 10. For aesthetical purposes, the external flanges 14 are in flush with the walls 24.

At 40, by welding, the ends of the unfinished external ring are connected to each other, and so are the ends of the unfinished internal ring. The welding can be argon-based welding or spot welding.

At 42, the rim is finished. By the grinding, any roughness of the rim, particularly in the areas of welding, is removed.

Spokes can be provided between a hub and the rim. A tube and a tire can be provided on the rim. Two beads of the tube can be inserted in the bead-receiving groove 11.

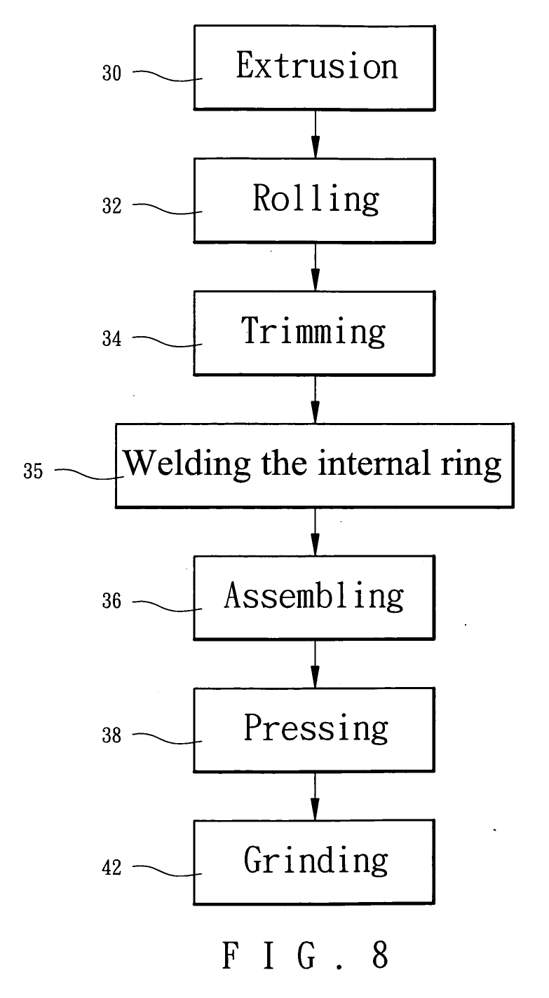

Referring to FIG. 8, there is shown another method for making the rim according to the first embodiment of the present invention. This method is like the foregoing method except including a step of welding (35) the internal ring 20 before mounting the external ring 10 on the internal ring 20. Omitted is the welding (40) of the external ring 10 in the foregoing method. Therefore, this method includes extrusion (30), rolling and cutting (32), trimming (34), welding (35) the internal ring 20, assembling (36), pressing (38) and grinding (42) in sequence.

The rim of the present invention exhibits several advantages over the prior art. Firstly, the strength is enhanced because of the deep V-shaped configuration of the internal ring 20 in the cross-sectional view without risks of causing wrinkles in the internal ring 20. This advantage results from the feature that the internal ring 20 and the external ring 10 are made separately and then assembled.

Secondly, time and related cost for making the rim are reduced.

Thirdly, it provides customers with various combinations of external ring with internal ring to best satisfy their needs. The external ring 10 and the internal ring 20 are made separately. Hence, they can be made of different materials. That is, a composite rim is possible.

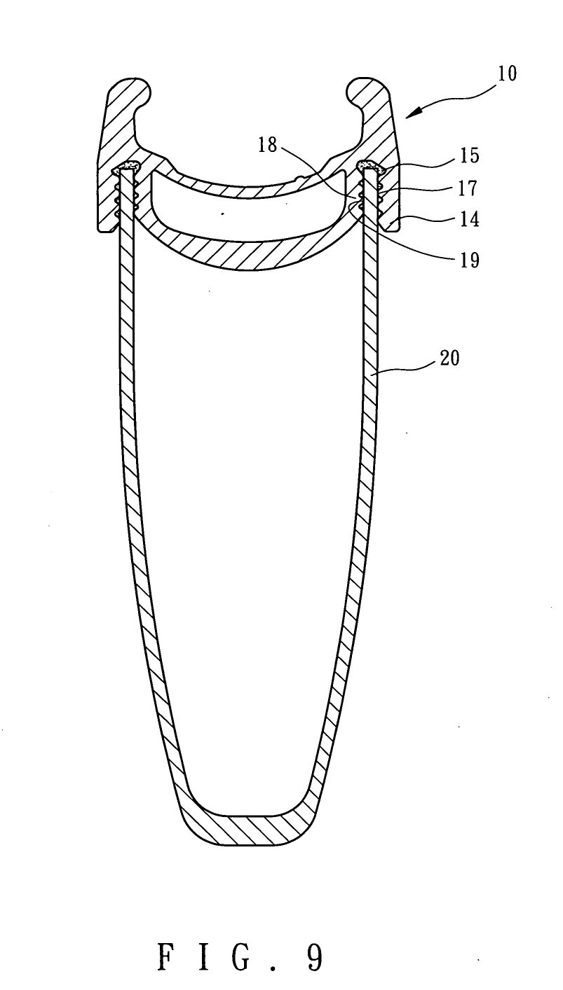

Referring to FIG. 9, there is shown a rim according to a second embodiment of the present invention. The second embodiment is identical to the first embodiment except two things. Firstly, glue 15 is filled in the edge-receiving grooves 13 to enhance the connection of the external ring 10 to the internal ring 20. Secondly, each of the external flanges 14 includes a rough face 17 for contact with a related one of the edges 21 to enhance the connection of the external ring 10 to the internal ring 20. Each of the internal flanges 18 includes a rough face 19 for contact with a related one of the edges 21 to enhance the connection of the external ring 10 to the internal ring 20.

It is preferred to make rim of the second embodiment according to the second method because the ends of the external ring 10 are not joined by welding and the glue 15 enhances the interconnection between the rings 10 and 20 and therefore the rigidity of the rim. Preferably, the position where the ends of the external ring 10 meet and the position where the ends of the internal ring 20 meet are at two ends of a diameter of the rim.

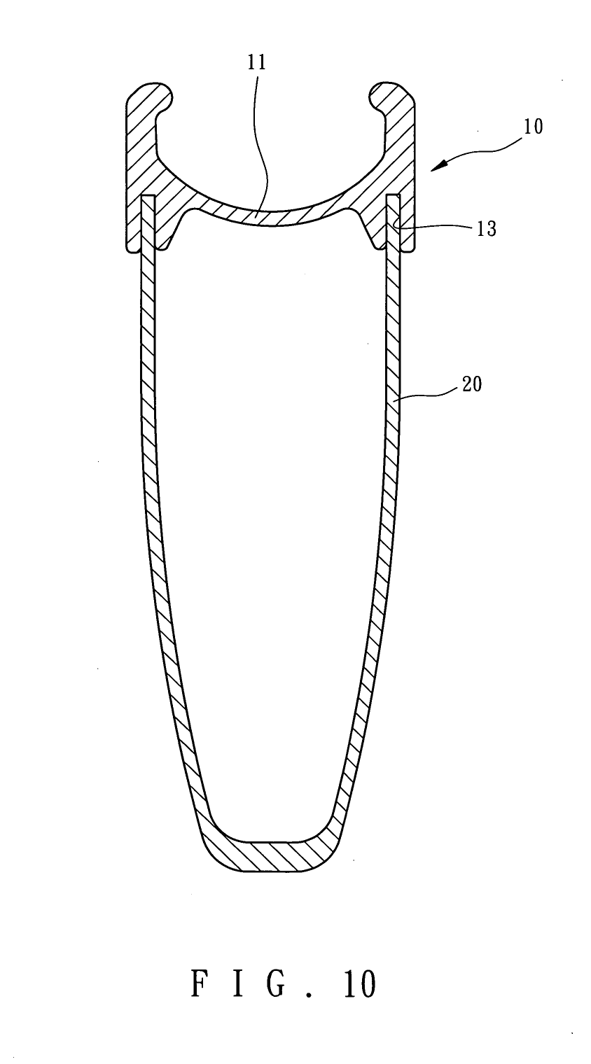

Referring to FIG. 10, there is shown a rim according to a third embodiment of the present invention. The third embodiment is like the first embodiment except a few things. Firstly, the enlarged portions 131 of the edge-receiving grooves 13 are omitted. Secondly, the slits 132 are omitted. Thirdly, the enlarged portions 211 of the edges 21 are omitted.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A rim comprising:
an external ring (10) including:
two walls (12);
a middle portion (16) interconnecting the walls (12);
a bead-receiving groove (11) defined by the walls (12) and the intermediate portion (16);
two external flanges (14) extending from the middle portion (16) opposite to the walls (12);
two internal flanges (18) extending from the middle portion (16) opposite to the walls (12), wherein the internal flanges (18) are located between the external flanges (14) in an axial direction of the rim; and
two edge-receiving grooves (13) each defined between a related one of the external flanges (14) and a related one of the internal flanges (18); and
an internal ring (20) including:
two walls (24) with an adequate dimension in a radial direction of the rim, wherein each of the walls (24) includes an edge (21) inserted in a related one of the edge-receiving grooves (13); and
an intermediate portion (26) interconnecting the walls (24).

2. The rim according to claim 1, wherein each of the edge-receiving grooves (13) includes an enlarged portion (131), wherein each of the edges (21) includes an enlarged portion (211) fit in the enlarged portion (131) of a related one of the edge-receiving grooves (13), enhancing the interconnection of the internal ring (20) and the external ring (10).

3. The rim according to claim 2, wherein the width of the edge-receiving grooves (13) decreases from an open end to a closed end except in the enlarged portion (131) to facilitate the insertion of the enlarged portion (211) of a related one of the edges (21) into the edge-receiving groove (13).

4. The rim according to claim 3, wherein the external ring (10) includes two slits (132) each defined in the closed end of a related one of the edge-receiving grooves (13), thus reducing stress exerted on the related external flange (14) of the external ring (10).

5. The rim according to claim 4, wherein each of the slits (132) extends towards the brake-contacting face of the related wall (12) of the external ring (10) from the closed end of the related edge-receiving groove (13).

6. The rim according to claim 1, wherein two ends of one of the external and internal rings (10, 20) are joined by welding.

7. The rim according to claim 6, including glue (15) filled in the edge-receiving grooves (13).

8. The rim according to claim 7, wherein each of the external and internal flanges (14, 18) of the external rings (10) includes a rough face (17, 19) in contact with a related one of the edges (21) of the internal ring (20).

9. The rim according to claim 1, wherein each of the walls (24) of the internal ring (20) includes a shoulder (22) abutted against a related one of the external flanges (14) of the external ring (10).

10. The rim according to claim 1, wherein each of the walls (12) of the external ring (10) includes a brake-contacting face, wherein each of the walls (24) of the internal ring (20) includes an external side in flush with the brake-contacting face of a related one of the walls (12) of the external ring (10).
